(19) United States
(12) Patent Application Publication
(10) Pub. No.: US 2026/0162455 A1
(43) Pub. Date: Jun. 11, 2026

(54) ELECTRONIC DEVICE AND METHOD FOR IDENTIFYING CHARACTERS INCLUDED IN IMAGE

(71) Applicant: SAMSUNG ELECTRONICS CO., LTD., Suwon-si (KR)

(72) Inventors: Jihoon KIM, Suwon-si (KR); Taewon KWAK, Suwon-si (KR); Dohyeon KIM, Suwon-si (KR); Jeongwan PARK, Suwon-si (KR); Jinsu SHIN, Suwon-si (KR); Donghyuk LEE, Suwon-si (KR)

(73) Assignee: SAMSUNG ELECTRONICS CO., LTD., Suwon-si (KR)

(21) Appl. No.: 19/180,959

(22) Filed: Apr. 16, 2025

Related U.S. Application Data
(63) Continuation of application No. PCT/KR2023/013999, filed on Sep. 15, 2023.

(30) Foreign Application Priority Data
Oct. 19, 2022 (KR) 10-2022-0135286
Oct. 21, 2022 (KR) 10-2022-0136917

(51) Int. Cl. G06V 30/246; G06V 30/148; G06V 30/19

(52) U.S. Cl. CPC G06V 30/246; G06V 30/153; G06V 30/19173; G06V 2201/02

(57) ABSTRACT

An electronic device includes, a first memory comprising one or more storage media storing instructions; a second memory; a display; and at least one processor comprising processing circuitry, wherein the instructions, when executed by the at least one processor individually or collectively, cause the electronic device to: identify characters in an image displayed through the display; based on categories distinguished by language of the characters, identify information, from the first memory, corresponding to a first category in which the characters are included; store, in the second memory, the information corresponding to the first category; and obtain text data corresponding to the characters, based on the information stored in the second memory.

### CROSS-REFERENCE TO RELATED APPLICATIONS

This application is a by-pass continuation application of International Application No. PCT/KR2023/013999, filed on Sep. 15, 2023, which is based on and claims priority to Korean Patent Application No. 10-2022-0135286, filed on Oct. 19, 2022, and Korean Patent Application No. 10-2022-0136917, filed on Oct. 21, 2022, in the Korean Intellectual Property Office, the disclosures of which are incorporated by reference herein their entireties.

### BACKGROUND

### 1. Field

The disclosure relates to an electronic device and a method for identifying characters included in an image.

### 2. Description of Related Art

An electronic device has been developed to extract text from an image including characters drawn by a user, written by the electronic device, and/or provided by an external electronic device different from the electronic device. The electronic device may identify the characters included in the image. The electronic device may identify strokes included in the image or printed characters.

### SUMMARY

According to an embodiment, an electronic device may comprise a first memory (e.g., a non-volatile memory) comprising one or more storage media storing instructions, a second memory (e.g., a volatile memory), a display, and at least one processor comprising processing circuitry. The instructions, when executed by the at least one processor individually or collectively, may cause the electronic device to identify characters in an image displayed through the display. The instructions, when executed by the at least one processor individually or collectively, may cause the electronic device to identify, based on categories distinguished by language of the characters, information, from the non-volatile memory, corresponding to a first category in which the characters are included. The instructions, when executed by the at least one processor individually or collectively, may cause the electronic device to store, in the volatile memory, the information corresponding to the first category. The instructions, when executed by the at least one processor individually or collectively, may cause the electronic device to obtain text data corresponding to the characters based on the information stored in the volatile memory.

According to an embodiment, a method of an electronic device may comprise identifying characters in an image displayed through a display in the electronic device. The method of the electronic device may comprise identifying, based on categories distinguished by language of the characters, information, from the non-volatile memory, corresponding to a first category in which the characters are included. The method of the electronic device may comprise storing, in the volatile memory, the information corresponding to the first category. The method of the electronic device may comprise obtaining text data corresponding to the characters based on the information stored in the volatile memory.

According to an embodiment, an electronic device may comprise a display, a volatile memory, a processor, and a non-volatile memory storing a plurality of language data sets including a first language data set, a second language data set, and a third language data set. The processor may identify, in an image, lines by which a plurality of characters are arranged. The processor may identify, based on categories distinguished by language of a character, a first category corresponding to a first line, and a second category corresponding to a second line among the plurality of lines. The processor may store, from the non-volatile memory to the volatile memory, the first language data set corresponding to the first category, and the second language data set corresponding to the second category among the plurality of language data sets. The processor may obtain, based on the stored first language data set and the second language data set, text data represented by the plurality of characters included in the lines.

According to an embodiment, a method of an electronic device may comprise identifying, in an image displayed through a display in the electronic device, lines by which a plurality of characters are arranged. The method of the electronic device may comprise identifying, based on categories distinguished by language of a character, categories respectively corresponding to the plurality of lines. The method of the electronic device may comprise storing information respectively corresponding to the identified categories from a non-volatile memory to a volatile memory, in the electronic device. The method of the electronic device may comprise obtaining, based on the stored information, text data represented by the plurality of characters included in the lines.

According to an embodiment, an electronic device may comprise a display, a non-volatile memory, a volatile memory, and a processor. The processor may identify, in an image displayed through the display, lines by which a plurality of characters are arranged. The processor may identify, based on categories distinguished by language of a character, categories respectively corresponding to the plurality of lines. The processor may store information respectively corresponding to the identified categories from the non-volatile memory to the volatile memory. The processor may obtain, based on the stored information, text data represented by the plurality of characters included in the lines.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment;

FIG. 2 illustrates an example of a block diagram of an electronic device according to an embodiment;

FIG. 3A illustrates an example of an electronic device that identifies characters in a screen displayed through a display, according to an embodiment;

FIG. 3B illustrates an example of an electronic device that identifies characters in a screen displayed through a display, according to an embodiment;

FIG. 4A illustrates an example of an electronic device that identifies characters in a screen displayed through a display, according to an embodiment;

FIG. 4B illustrates an example of an electronic device that identifies characters in a screen displayed through a display, according to an embodiment;

FIG. 5 illustrates an example of an electronic device that identifies characters in a screen displayed through a display, according to an embodiment;

FIG. 6 illustrates an example of a usage of a volatile memory of an electronic device according to an embodiment;

FIG. 7 illustrates an example of a flowchart of an operation of an electronic device according to an embodiment;

FIG. 8 illustrates an example of a flowchart of an operation of an electronic device according to an embodiment;

FIG. 9 illustrates an example of a flowchart of an operation of an electronic device according to an embodiment;

FIG. 10 illustrates an example of a flowchart of an operation of an electronic device according to an embodiment; and

FIG. 11 illustrates an example of a flowchart of an operation of an electronic device according to an embodiment.

### DETAILED DESCRIPTION

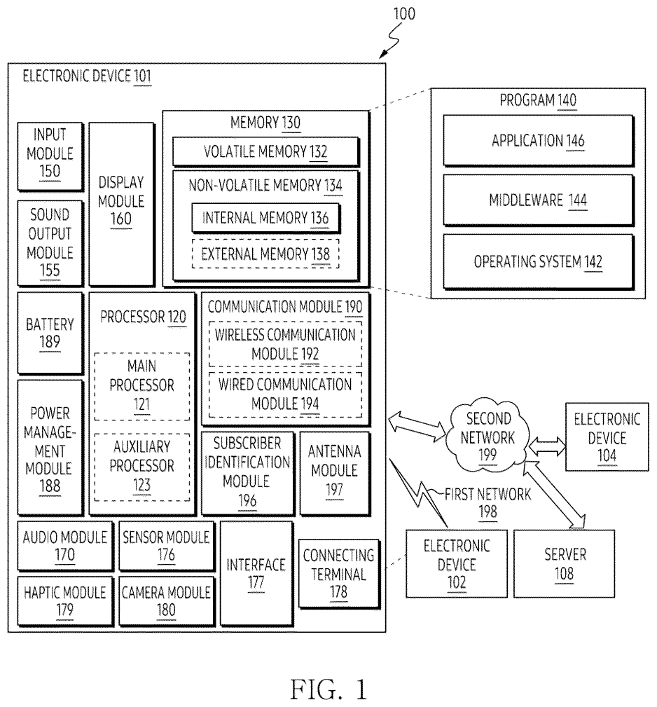

FIG. 1 illustrates an electronic device in a network environment according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. In some embodiments, the non-volatile memory 134 may be a first memory. In some embodiments, the volatile memory 132 may be a second memory.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited to the above examples of the artificial neural network. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related to the software. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire(s)) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire(s)) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to some embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

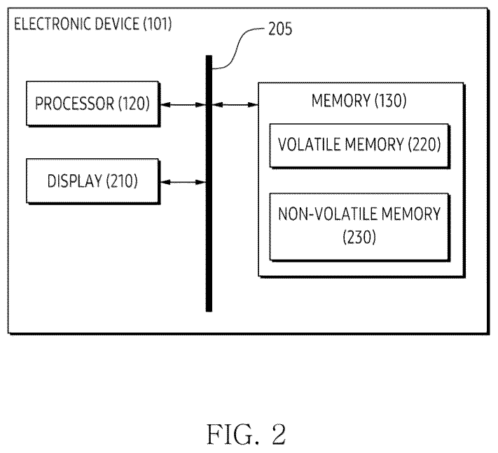

FIG. 2 illustrates an example of a block diagram of an electronic device according to an embodiment. An electronic device 101 of FIG. 2 may include the electronic device 101 of FIG. 1. A processor 120 of FIG. 2 may include the processor 120 of FIG. 1. A display 210 of FIG. 2 may include the display module 160 of FIG. 1. Memory 130 of FIG. 2 may include the memory 130 of FIG. 1. A volatile memory 220 of FIG. 2 may include the volatile memory 132 of FIG. 1. A non-volatile memory 230 of FIG. 2 may include the non-volatile memory 134 of FIG. 1. Operations of FIG. 2 may be executed by the processor 120 of FIG. 1.

Referring to FIG. 2, according to an embodiment, the electronic device 101 may include the processor 120, the display 210, and the memory 130. The processor 120, the display 210, and the memory 130 may be electronically and/or operably coupled with each other by an electrical component such as a communication bus 205. Hereinafter, hardware being operably coupled may mean that a direct connection or an indirect connection between the hardware is established by wire or wirelessly so that second hardware is controlled by first hardware among the hardware. FIG. 2 illustrates different blocks. However, the disclosure is not limited to the above example embodiments. For example, at least a portion of the hardware of FIG. 2 (e.g., at least a portion of the processor 120 and the memory 130) may be included in a single integrated circuit, such as a system on a chip (SOC). A type and/or the number of hardware included in the electronic device 101 is not limited as illustrated in FIG. 2. For example, the electronic device 101 may include only some of the hardware illustrated in FIG. 2.

According to an embodiment, the processor 120 of the electronic device 101 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 120 may have a structure of a single-core processor, or may have a structure of a multi-core processor such as a dual core, a quad core, a hexa core, or an octa core.

The memory 130 of the electronic device 101 may include a hardware component for storing data and/or instruction inputted and/or outputted from the processor 120 of the electronic device 101. The memory 130 may include, for example, the volatile memory 220 such as a random-access memory (RAM), and/or the non-volatile memory 230 such as a read-only memory (ROM). The volatile memory 220 may include, for example, at least one of a dynamic RAM (DRAM), a static RAM (SRAM), a cache RAM, and a pseudo RAM (PSRAM). The non-volatile memory 230 may include, for example, at least one of a programmable ROM (PROM), an erasable PROM (EPROM), an electrically erasable PROM (EEPROM), a flash memory, a hard disk, a compact disk, a solid state drive (SSD), and an embedded multimedia card (eMMC). According to an embodiment, the electronic device 101 may identify categories distinguished by language of a character in the non-volatile memory 220. For example, the categories distinguished by the language may be related to visually expressed letters for communication of users belonging to a specific group (e.g., a country or an area). For example, the categories distinguished by the language may include categories such as Korean, English, Chinese, Japanese, Spanish, and Portuguese. However, the disclosure is not limited to the above categories.

According to an embodiment, the display 210 of the electronic device 101 may output visualized information to a user. For example, the display 210 may output the visualized information to the user, which is controlled by the processor 120 including a circuit such as a graphic processing unit (GPU). The display 210 may include a flat panel display (FPD) and/or electronic paper. The FPD may include a liquid crystal display (LCD), a plasma display panel (PDP), and/or one or more light emitting diodes (LEDs). The LED may include an organic LED (OLED).

According to an embodiment, the electronic device 101 may display an image through the display 210. The electronic device 101 may identify characters in the image displayed through the display 210. The electronic device 101 may obtain text corresponding to the characters, based on the characters. For example, the electronic device 101 may display a handwriting character and/or printed characters through the display 210. For example, the handwriting character may be related to the characters. The handwriting character may include one or more lines drawn on a side by the user in order to convey a linguistic meaning. The disclosure is not limited to the above example embodiment. In an embodiment, the handwriting character may include one or more lines drawn on the side to convey a user's intention (e.g., a non-linguistic meaning of the user) that is different from the linguistic meaning. For example, the printed characters may include characters written by the electronic device 101 or provided by an external electronic device different from the electronic device 101. For example, the printed characters may include characters written based on a font stored in memory of the electronic device 101 and/or the external electronic device. Hereinafter, the characters may include a handwriting character and/or letters related to a printed character.

According to an embodiment, the electronic device 101 may execute an optical character recognition (OCR) function for obtaining text from the characters. The electronic device 101 may form an area in the volatile memory 220 to execute the OCR function. The electronic device 101 may perform initialization to form the area. While performing the initialization, the electronic device 101 may secure at least a portion of an area of the volatile memory 220. The initialization may include an operation for securing at least a portion of the area of the volatile memory 220. Storing information from the non-volatile memory 230 to the volatile memory 220 (which will be described later,) may include an operation of transmitting information stored in the non-volatile memory 230 to the volatile memory 220. The information being stored from the non-volatile memory 230 to the volatile memory 220 to be described later may include an operation of allocating the information stored in the non-volatile memory 230 to an area of the volatile memory 220. The information (being stored from the non-volatile memory 230 to the volatile memory 220 to be described later) may include an operation of storing the information stored in the non-volatile memory 230 in an area of the volatile memory 220.

According to an embodiment, the electronic device 101 may identify blocks in which the characters are arranged in an image displayed through the display 210. The block may be referred to as ‘an area’ in the image. The electronic device 101 may identify lines by which the plurality of characters are arranged in the image. The lines may be referred to as ‘a partial area’ included in the area. The blocks and/or lines may be obtained based on information (or data) obtained based on hardware (e.g., a neural processing unit (NPU), and/or a graphic processing unit (GPU)) for performing computations related to an artificial intelligence, software for providing a function related to the artificial intelligence, and/or an external electronic device (e.g., a server that provides the function related to the artificial intelligence).

According to an embodiment, the electronic device 101 may identify a category distinguished by language of characters. For example, the category distinguished by the language of the characters may be distinguished by a type of the language. For example, the category distinguished by the language of the characters may be matched to the type of the language of the characters. For example, the electronic device 101 may identify the category matching the characters based on identifying the characters. For example, the electronic device 101 may identify categories distinguished by language stored in the non-volatile memory 230. The electronic device 101 may identify information matching a first category in which the characters are included from the non-volatile memory 230. The electronic device 101 may store the information in the volatile memory 220 based on identifying the information matching the first category. The electronic device 101 may store the information in an area formed in the volatile memory 220. The electronic device 101 may assign the information in an area formed in the volatile memory 220. For example, the electronic device 101 may identify a plurality of lines by which the characters are arranged in the image. For example, the electronic device 101 may identify a block including the plurality of lines by which the characters are arranged in the image. The electronic device 101 may identify the plurality of lines included in the block based on identifying the block including the plurality of lines. The electronic device 101 may identify categories matching each of the lines based on identifying the plurality of lines. The electronic device 101 may store information related to the categories stored in the non-volatile memory 230, in the volatile memory 220, based on identifying the categories matching each of the lines.

For example, the information related to the categories, and/or information corresponding to the categories, may include data for identifying characters displayed in the image. For example, the information related to the categories, and/or the information corresponding to the categories, may include a set of data for identifying the characters displayed in the image. The set of data may include a parameter (e.g., weights between nodes included in a neural network) for forming the neural network for identifying the a character from the image, based on language corresponding to the category. The set of data may include one or more reference images (e.g., an image in which characters of the language corresponding to the category are individually captured) for identifying the characters. The set of data may include corpora including a reference image and pairs of text data matched to the reference image. The set of data may include a set of natural language words (e.g., a dictionary) based on language corresponding to a category. For example, the information related to the categories, and/or the information corresponding to the categories, may include a database for identifying the language of the characters. For example, the information related to the categories and/or the information corresponding to the categories may be referred to as a ‘language database (DB)’.

According to an embodiment, the electronic device 101 may identify duplicate categories among categories matching each of the plurality of lines. For example, the electronic device 101 may identify the first category matching a first line. The electronic device 101 may identify the first category matching a second line. The electronic device 101 may identify that the categories of the first line and the second line are the first category. The electronic device 101 may identify that the categories of the first line and the second line are the same. The electronic device 101 may store information related to the first category from the non-volatile memory 230 to the volatile memory 220, based on identifying the first category matching the first line. The electronic device 101 may identify the first category matching the second line, based on storing the information related to the first category in the volatile memory 220. The electronic device 101 may bypass storing information related to the first category matching the second line in the volatile memory 220, based on identifying the first category matching the second line. For example, when identifying the same category, the electronic device 101 may store information corresponding to the category only once in the volatile memory 220.

According to an embodiment, the electronic device 101 may discard information corresponding to a category matching each of the lines stored in the volatile memory 220, based on usage of the volatile memory 220. For example, the electronic device 101 may identify the number of information corresponding to the category related to the usage of the volatile memory 220. The electronic device 101 may identify the number of information corresponding to categories that may be stored in the volatile memory 220. For example, the electronic device 101 may identify a threshold (e.g., five) of the information corresponding to the categories that may be stored in the volatile memory 220. The number or the threshold of the categories that may be stored in the volatile memory 220 may be related to the capacity of the volatile memory 220. The electronic device 101 may store more categories as the capacity of the volatile memory 220 increases.

According to an embodiment, the electronic device 101 may store information matching the first category in the volatile memory 220. The first category may be a category that matches language of characters identified in an image. The electronic device 101 may obtain text data corresponding to characters displayed through the display 210 based on storing the information matching the first category in the volatile memory 220. The electronic device 101 may display text matching the text data through the display 210, based on obtaining the text data. For example, the electronic device 101 may display text matching the characters superimposed on an image displayed in the display 210.

As described above, according to an embodiment, the electronic device 101 may display an image through the display 210. The electronic device 101 may identify characters in the image. The electronic device 101 may identify categories distinguished by language of the characters. The electronic device 101 may identify information matching the first category in which the characters are included from the non-volatile memory 230. The electronic device 101 may identify the information matching the first category in which the characters are included from the non-volatile memory 230, based on identifying the categories distinguished by the language of the characters. The electronic device 101 may store the information corresponding to the first category from the non-volatile memory 230 to the volatile memory 220. The electronic device 101 may obtain text data corresponding to the characters, based on the information stored in the volatile memory 220. The electronic device 101 may display text related to the text data. The electronic device 101 may display the text related to the text data through the display 210, based on obtaining the text data corresponding to the characters. The electronic device 101 may reduce the usage of the volatile memory 220 by storing information corresponding to a category corresponding to the identified characters from the non-volatile memory 230 to the volatile memory 220.

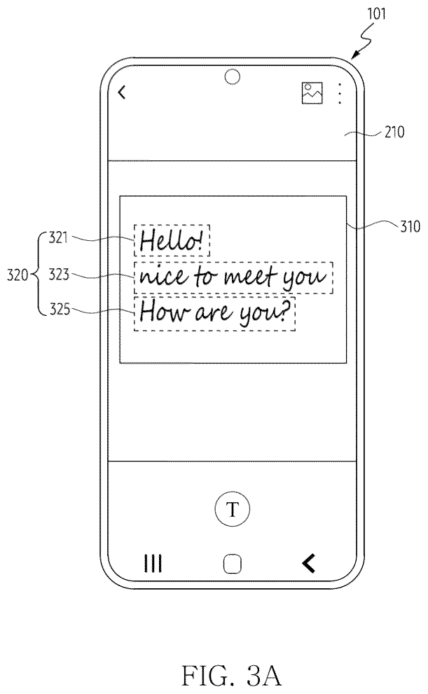

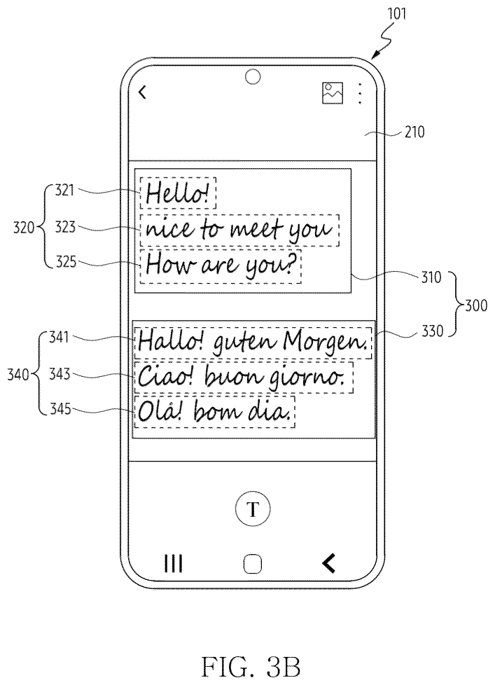

FIG. 3A illustrates an example of an electronic device that identifies characters in a screen displayed through a display, according to an embodiment. FIG. 3B illustrates an example of an electronic device that identifies characters in a screen displayed through a display, according to an embodiment. An electronic device 101 of FIGS. 3A and 3B may include the electronic device 101 of FIGS. 1 and/or 2. A display 210 of FIGS. 3A and 3B may include the display module 160 of FIG. 1 and/or the display 210 of FIG. 2. Operations of FIGS. 3A and 3B may be executed by the processor 120 of FIGS. 1 and/or 2.

Referring to FIGS. 3A and 3B, according to an embodiment, the electronic device 101 may display an image through the display 210. The electronic device 101 may identify characters in the image. The electronic device 101 may identify a block 310 including the characters. For example, the block 310 may be referred to as ‘an area’. The electronic device 101 may identify lines 320 included in the block 310. For example, the lines 320 may be referred to as ‘partial areas’ including a plurality of characters. Hereinafter, the block 310 may include an area, and the lines 320 may include the partial areas included in the area. A first line 321, a second line 323, and a third line 325 may be included in the lines 320. The disclosure is not limited to the above example embodiment.

According to an embodiment, the electronic device 101 may store a plurality of language database (DB) stored in a non-volatile memory (e.g., the non-volatile memory 230 of FIG. 2). For example, the electronic device 101 may store a first language DB corresponding to Korean, a second language DB corresponding to English, and a third language DB corresponding to Chinese, in the non-volatile memory (e.g., the non-volatile memory 230 of FIG. 2).

According to an embodiment, the electronic device 101 may identify characters included in the image. The electronic device 101 may identify the lines 320 including the characters. The electronic device 101 may identify the lines 320 based on identifying the characters. The electronic device 101 may identify categories distinguished by language of the characters included in the lines 320 based on identifying the lines 320. For example, the electronic device 101 may identify categories respectively corresponding to the lines 320 among the categories distinguished by the language of the characters stored in the non-volatile memory (e.g., the non-volatile memory 230 of FIG. 2).

According to an embodiment, the electronic device 101 may identify that a category distinguished by language of characters included in the lines 320 is not stored in the non-volatile memory. The electronic device 101 may display a visual object through the display 210 based on failure to identify the category distinguished by the language of the characters in the non-volatile memory. For example, the visual object may be displayed as a user interface (UI), such as ‘There is no recognition result.’.

Referring to FIG. 3A, according to an embodiment, the electronic device 101 may identify a category of characters included in the lines 320. For example, the electronic device 101 may identify the first line 321 including ‘Hello!’. The electronic device 101 may identify the second line 323 including ‘nice to meet you.’. The electronic device 101 may identify the third line 325 including ‘How are you?’. The electronic device 101 may identify a category matching the lines 320 based on identifying the lines 320. In an example of FIG. 3A, the electronic device 101 may identify ‘English’, which is a category corresponding to the characters included in the lines 320. The electronic device 101 may store information corresponding to ‘English’ stored in the non-volatile memory, in a volatile memory (e.g., the volatile memory 220 of FIG. 2), based on identifying the category corresponding to the characters included in the lines 320. For example, the electronic device 101 may allocate the information corresponding to ‘English’ stored in the non-volatile memory to an area of the volatile memory. The electronic device 101 may obtain text data corresponding to the characters based on the information corresponding to ‘English’ stored in the volatile memory. The electronic device 101 may display text for expressing the text data through the display 210 based on obtaining the text data.

According to an embodiment, the electronic device 101 may identify ‘English’, which is a type of language corresponding to the characters included in the lines 320. The electronic device 101 may store a language DB corresponding to ‘English’ among a plurality of language DBs stored in the non-volatile memory, based on identifying the type of language corresponding to the characters included in the lines 320, in the volatile memory (e.g., the volatile memory 220 of FIG. 2). For example, the electronic device 101 may allocate the language DB corresponding to ‘English’ stored in the non-volatile memory to an area of the volatile memory. The electronic device 101 may obtain text data corresponding to the characters based on the language DB corresponding to ‘English’ stored in the volatile memory. The electronic device 101 may display text for expressing the text data through the display 210 based on obtaining the text data.

Referring to FIG. 3B, according to an embodiment, the electronic device 101 may display an image through the display 210. The electronic device 101 may identify a plurality of blocks 300 including a plurality of characters in the image. The electronic device 101 may identify lines 320 and 340 included in the plurality of blocks 300. The electronic device 101 may identify the lines 320 and 340 including the plurality of characters. The electronic device 101 may identify at least one of the blocks 300 and the lines 320 and 340. The electronic device 101 may identify a category of each of the lines 320 and 340 including the plurality of characters.

In an example of FIG. 3B, the electronic device 101 may identify a category of the first line 321 including ‘Hello!’. The electronic device 101 may identify the category of the first line 321 as ‘English’, which is a first category. The electronic device 101 may identify a category of the second line 323 including ‘nice to meet you.’. The electronic device 101 may identify the category of the second line 323 as ‘English’, which is the first category. The electronic device 101 may identify a category of the third line 325 including ‘How are you?’. The electronic device 101 may identify the category of the third line 325 as ‘English’, which is the first category. The electronic device 101 may identify whether first information corresponding to the first category is stored in the non-volatile memory, based on identifying the categories of the first line 321 to the third line 325 as ‘English’, which is the first category. The electronic device 101 may store the first information corresponding to the first category stored in the non-volatile memory, from the non-volatile memory to the volatile memory.

According to an embodiment, the electronic device 101 may identify a fourth line 341 including ‘hallo! guten Morgen.’. The electronic device 101 may identify a category of the fourth line 341 including ‘hallo! guten Morgen.’. The electronic device 101 may identify the category of the fourth line 341 as ‘German’, which is a second category. The electronic device 101 may identify whether second information corresponding to the second category is stored in the non-volatile memory, based on identifying the category of the fourth line 341 as the second category. The electronic device 101 may identify that the second information corresponding to the second category is stored. The electronic device 101 may store the second information from the non-volatile memory to the volatile memory, based on identifying the second information stored in the non-volatile memory. The electronic device 101 may store the first information corresponding to the first category, and then store the second information corresponding to the second category.

For example, the electronic device 101 may identify a fifth line 343 including ‘Ciao! buon giorno.’. The electronic device 101 may identify a category of the fifth line 343 including ‘Ciao! buon giorno.’. The electronic device 101 may identify the category of the fifth line 343 as ‘Italian’, which is a third category. The electronic device 101 may identify whether third information corresponding to the third category is stored in the non-volatile memory, based on identifying the category of the fifth line 343 as the third category. The electronic device 101 may identify that the third information is stored in the non-volatile memory. The electronic device 101 may store the third information stored in the non-volatile memory from the non-volatile memory to the volatile memory. The electronic device 101 may store the third information after storing the first information and the second information. For example, the electronic device 101 may identify a sixth line 345 including ‘Olα! bom dia.’. The electronic device 101 may identify a category of the sixth line 345 including ‘Olα! bom dia.’. The electronic device 101 may identify the category of the sixth line 345 as ‘Portuguese’, which is a fourth category. The electronic device 101 may identify whether fourth information corresponding to the fourth category is stored in the non-volatile memory, based on identifying the category of the sixth line 345 as the fourth category. The electronic device 101 may identify that the fourth information corresponding to the fourth category is stored in the non-volatile memory. The electronic device 101 may store the fourth information corresponding to the fourth category from the non-volatile memory to the volatile memory, based on identifying the fourth information corresponding to the fourth category stored in the non-volatile memory. For example, the electronic device 101 may store the fourth information in the volatile memory after storing the first information to the third information in the volatile memory.

According to an embodiment, the electronic device 101 may identify information respectively corresponding to a plurality of lines 320 and 340 stored in the volatile memory. The electronic device 101 may obtain text data related to characters included in the plurality of lines 320 and 340 based on the information. The electronic device 101 may obtain text data related to the characters based on each of categories matching the characters. The electronic device 101 may display text for expressing the characters included in the plurality of lines 320 and 340, based on obtaining text data respectively corresponding to the plurality of lines 320 and 340 through the display 210.

As described above, according to an embodiment, the electronic device 101 may identify the plurality of lines 320 and 340 including the plurality of characters. The electronic device 101 may identify a category that matches the characters included in the plurality of lines 320 and 340 and is distinguished by language of the characters. The electronic device 101 may identify categories matching each of the plurality of lines 320 and 340. The electronic device 101 may store information matching the categories from the non-volatile memory to the volatile memory, based on identifying the categories matching each of the plurality of lines 320 and 340. The electronic device 101 may obtain text data for expressing the characters based on the information matching the categories stored in the volatile memory. The electronic device 101 may display text related to the characters through the display 210 based on obtaining the text data. The electronic device 101 may allocate categories matching the characters to the volatile memory. The electronic device 101 may reduce a usage of the volatile memory by allocating only the categories matching the characters to the volatile memory.

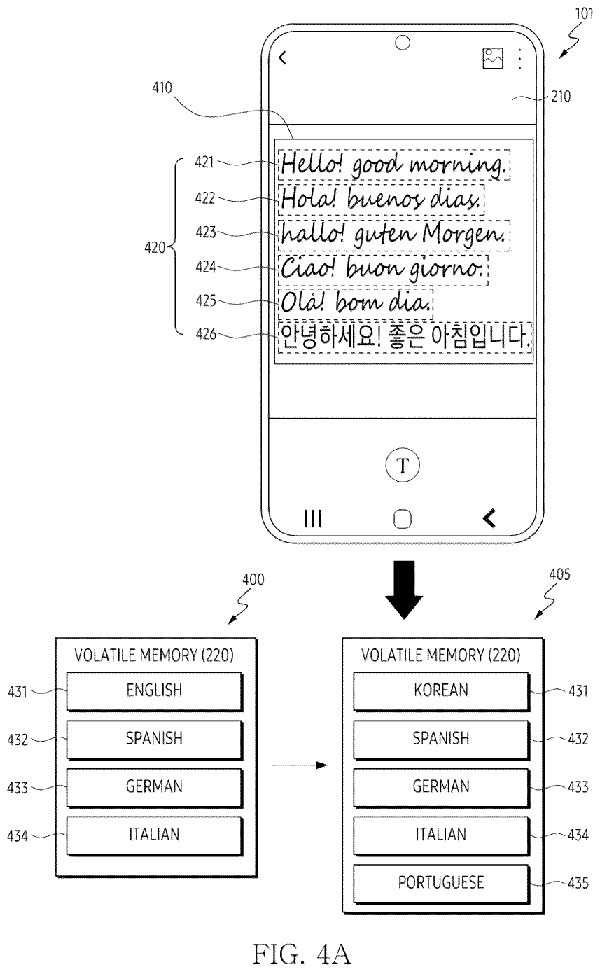

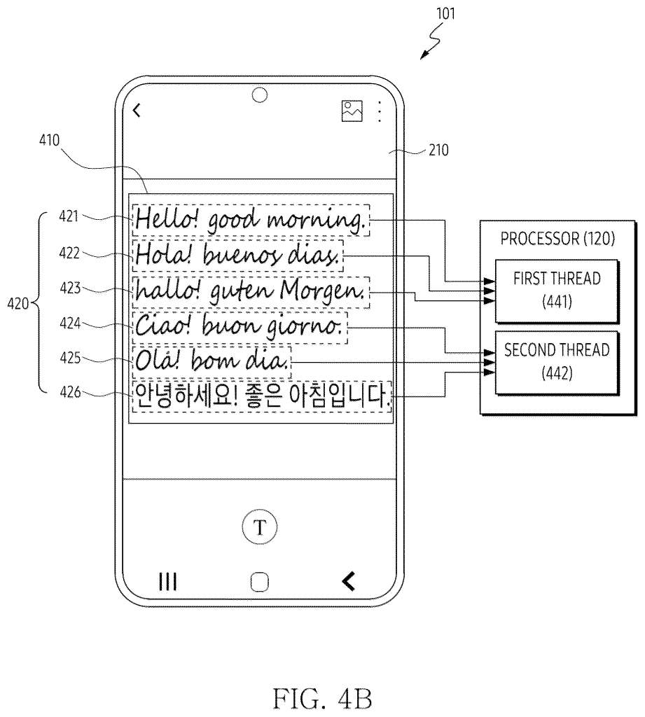

FIG. 4A illustrates an example of an electronic device that identifies characters in a screen displayed through a display, according to an embodiment. FIG. 4B illustrates an example of an electronic device that identifies characters in a screen displayed through a display, according to an embodiment. An electronic device 101 of FIGS. 4A and 4B may include the electronic device 101 of FIGS. 1, 2, 3A, and/or 3B. Operations of FIGS. 4A and 4B may be executed by the processor 120 of FIGS. 1 and/or 2.

Referring to FIGS. 4A and 4B, according to an embodiment, the electronic device 101 may display an image through a display 210. The electronic device 101 may identify characters in the image. The electronic device 101 may identify a block 410 in the image. The electronic device 101 may identify lines 420 included in the block 410. The electronic device 101 may identify characters included in the lines 420. The electronic device 101 may identify categories matching each of the lines 420 based on the characters included in the lines 420. The electronic device 101 may identify information matching the categories stored in a non-volatile memory (e.g., the non-volatile memory 230 of FIG. 2), based on identifying the categories matching each of the lines 420. The electronic device 101 may store the information matching the categories from the non-volatile memory to a volatile memory 220, based on identifying the information matching the categories. According to an embodiment, the electronic device 101 may identify a first line 421 to a sixth line 426 including the characters. The electronic device 101 may identify categories matching the first line 421 to the sixth line 426. For example, the electronic device 101 may identify categories distinguished by language of the characters, based on the characters included in the first line 421 to the sixth line 426. For example, the electronic device 101 may identify ‘Hello! good morning.’ included in the first line 421. The electronic device 101 may identify a first category, which is a category distinguished by language of ‘Hello! good morning.’. For example, the first category may be ‘English’. The electronic device 101 may identify ‘Hola! buenos dias.’ included in a second line 422. The electronic device 101 may identify a second category, which is a category distinguished by language of ‘Hola! buenos dias.’ included in the second line 422. For example, the second category may be ‘Spanish’. The electronic device 101 may identify ‘hallo! guten Morgen.’ included in a third line 423. The electronic device 101 may identify a third category, which is a category distinguished by language of ‘hallo! guten Morgen.’. For example, the third category may be ‘German’. The electronic device 101 may identify ‘Ciao! buon giorno.’ included in a fourth line 424. The electronic device 101 may identify a fourth category, which is a category distinguished by language of ‘Ciao! buon giorno.’. For example, the fourth category may be ‘Italian’. The electronic device 101 may identify ‘Olα! bom dia.’ included in a fifth line 425. The electronic device 101 may identify a fifth category, which is a category distinguished by language of ‘Olα! bom dia.’. For example, the fifth category may be ‘Portuguese’. The electronic device 101 may identify ‘ [symbol] ,’ included in a sixth line 426. The electronic device 101 may identify a sixth category, which is a category distinguished by language of ‘ [symbol] ’. For example, the sixth category may be ‘Korean’. The electronic device 101 may store information (e.g., a language DB) respectively corresponding to the first category to the sixth category, from the non-volatile memory to the volatile memory 220, based on identifying the first category to the sixth category.

Referring to FIG. 4A, according to an embodiment, the electronic device 101 may allocate information related to categories matching the first line 421 to the fourth line 424 to the volatile memory 220 in a state 400 in which the first line 421 to the fourth line 424 are identified. For example, the electronic device 101 may store information corresponding to the categories matching the first line 421 to the fourth line 424 in areas formed in the volatile memory 220.

For example, the electronic device 101 may identify the first category distinguished by characters included in the first line 421. The electronic device 101 may store first information (e.g., a first language DB) corresponding to the first category, from the non-volatile memory to a first area 431 of the volatile memory 220. The electronic device 101 may identify the second category distinguished by characters included in the second line 422. The electronic device 101 may store second information (e.g., a second language DB) corresponding to the second category, from the non-volatile memory to a second area 432 of the volatile memory 220. The electronic device 101 may identify the third category distinguished by characters included in the third line 423. The electronic device 101 may store third information (e.g., a third language DB) corresponding to the third category from the non-volatile memory to a third area 433 of the volatile memory 220. The electronic device 101 may identify the fourth category distinguished by characters included in the fourth line 424. The electronic device 101 may store fourth information (e.g., a fourth language DB) corresponding to the fourth category, from the non-volatile memory to a fourth area 434 of the volatile memory 220.

According to an embodiment, the electronic device 101 may identify, in the state 400 in which the first information to the fourth information is stored, the fifth line 425 and the sixth line 426, in the first area 431 to the fourth area 434. The electronic device 101 may identify a category distinguished by characters included in the fifth line 425, based on identifying the fifth line 425. For example, the electronic device 101 may identify the fifth category distinguished by characters included in the fifth line 425. The electronic device 101 may store fifth information (e.g., a fifth language DB) corresponding to the fifth category, from the non-volatile memory to a fifth area 435 of the volatile memory 220. The electronic device 101 may identify a category distinguished by characters included in the sixth line 426. The electronic device 101 may identify the sixth category distinguished by characters included in the sixth line 426. The electronic device 101 may store sixth information (e.g., a sixth language DB) corresponding to the sixth category, from the non-volatile memory to the volatile memory 220, based on identifying the sixth category. The electronic device 101 may identify a usage in the volatile memory 220 to store the sixth information (e.g., the sixth language DB). The electronic device 101 may discard the first information corresponding to the first category distinguished by characters included in the first line 421, based on the usage being greater than a preset usage. For example, the electronic device 101 may identify the number of times categories distinguished by characters included in the lines 420 are identified. The electronic device 101 may discard information stored in an area of the volatile memory 220 based on the identified number of times. For example, the electronic device 101 may discard information corresponding to a first identified line among the lines 420. For example, the electronic device 101 may identify whether the number of language DBs stored in the volatile memory 220 is greater than the number of preset language DBs. For example, the electronic device 101 may discard the language DB corresponding to the first identified line among the lines 420, when determining that the number of language DBs stored in the volatile memory 220 is greater than the number of preset language DBs. In a state 405 of FIG. 4A, the electronic device 101 may discard ‘English’, which is the first information corresponding to the first line 421, with priority over other information. The electronic device 101 may store the sixth information in the first area 431 based on discarding of the first information.

Referring to FIG. 4B, according to an embodiment, the electronic device 101 may identify the block 410 in an image displayed through the display 210. The electronic device 101 may identify the lines 420 included in the block 410. The electronic device 101 may identify characters included in the lines 420. The electronic device 101 may identify a category of each of the lines 420 based on the characters included in each of the lines 420.

According to an embodiment, the electronic device 101 may allocate the lines to a thread of a processor 120 to identify the category matching the lines. For example, the electronic device 101 may allocate the first line to k-th line to a first thread 441. The electronic device 101 may allocate k+1-th line to n-th line to a second thread 442. The k and the n may be natural numbers for representing at least a portion of the lines identified in the image. When identifying each category of the lines 420, the electronic device 101 may allocate at least a portion of the lines 420 to the first thread 441 of the processor 120. For example, the electronic device 101 may preset the number of the lines 420 to be allocated to the first thread 441. The electronic device 101 may allocate a remaining portion excluding at least a portion of the lines 420 to the second thread 442 of the processor 120. For example, the electronic device 101 may identify the category distinguished by the characters included in the lines 420, based on the assignment of each line 420 to the first thread 441 and the second thread 442.

In an example of FIG. 4B, the electronic device 101 may allocate the first line 421 to the third line 423 to the first thread 441. The electronic device 101 may identify categories distinguished by characters included in the first line 421 to the third line 423, based on execution of the first thread 441. The electronic device 101 may store information corresponding to the categories from the non-volatile memory to the volatile memory based on the identification of the categories. The electronic device 101 may store the information corresponding to the categories in an area formed in the volatile memory from the non-volatile memory. The electronic device 101 may allocate the fourth line 424 to the sixth line 426 to the second thread 442. The electronic device 101 may identify categories distinguished by characters included in the fourth line 424 to the sixth line 426, based on execution of the second thread 442. The electronic device 101 may identify the categories matching the fourth line 424 to the sixth line 426. The electronic device 101 may store information corresponding to the categories from the non-volatile memory to the volatile memory, based on identifying the categories matching the fourth line 424 to the sixth line 426.

Referring to FIGS. 4A and 4B, according to an embodiment, the electronic device 101 may store information obtained based on the lines 420 in the volatile memory 220. The electronic device 101 may obtain text data related to characters included in the lines 420, based on the information stored in areas 431 to 435 formed in the volatile memory 220. The electronic device 101 may display text matching the first line 421 to the sixth line 426 based on obtaining the text data.

As described above, according to an embodiment, the electronic device 101 may identify the lines 420. The electronic device 101 may identify characters included in the lines 420. The electronic device 101 may identify a category distinguished by language of the characters included in the lines 420. The electronic device 101 may obtain information related to the category from the non-volatile memory, based on identifying the category. The electronic device 101 may store the information obtained from the non-volatile memory, in the volatile memory 220. The electronic device 101 may store information related to the characters matching the identified lines 420, from the non-volatile memory to the volatile memory 220. The electronic device 101 may obtain text data related to the characters included in the lines 420 based on the information stored in the volatile memory 220. The electronic device 101 may display text for expressing the characters, based on obtaining the text data. The electronic device 101 may reduce a usage of the volatile memory 220, by storing the information related to the characters from the non-volatile memory to the volatile memory 220, based on the category distinguished by the language of the characters included in the identified lines 420.

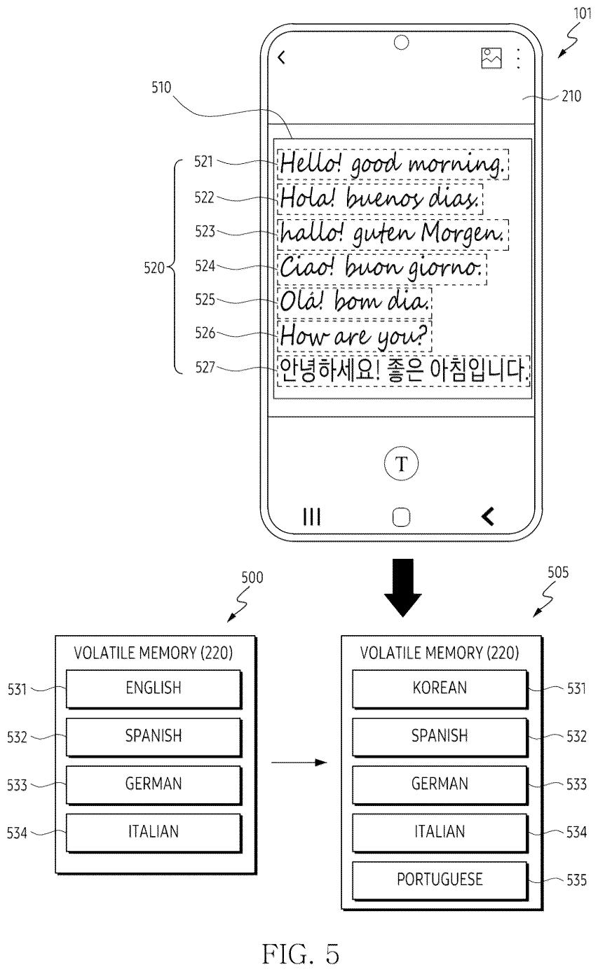

FIG. 5 illustrates an example of an electronic device that identifies characters in a screen displayed through a display, according to an embodiment. An electronic device 101 of FIG. 5 may include the electronic device 101 of FIGS. 1, 2, 3A, 3B, 4A, and/or 4B. A display 210 of FIG. 5 may include the display module 160 of FIG. 1, and the display 210 of FIGS. 2, 3A, 3B, 4A, and/or 4B. Operations of FIG. 5 may be executed by the processor 120 of FIGS. 1, 2, and/or 4B.

Referring to FIG. 5, according to an embodiment, the electronic device 101 may display an image through the display 210. While displaying the image through the display 210, the electronic device 101 may identify a block 510 included in the image. The electronic device 101 may identify lines 520 included in the block 510. The electronic device 101 may identify characters included in the lines 520. The electronic device 101 may identify a category distinguished by language of the characters, based on the characters included in each of the lines 520. The electronic device 101 may identify the number of times the category matching each of the lines 520 is identified. The electronic device 101 may identify a frequency at which the category matching each of the lines 520 is identified. The electronic device 101 may generate a table including the number of times based on identifying the identified number of times (or frequency). The electronic device 101 may preset information stored in a volatile memory 220 based on data included in the table. The electronic device 101 may discard the information stored in the volatile memory 220 based on the data included in the table. For example, the electronic device 101 may discard information corresponding to a category in which a relatively small number of times is identified in the volatile memory 220.

In an example of FIG. 5, the electronic device 101 may identify ‘English’, which is a first category matching a first line 521. The electronic device 101 may identify ‘Spanish’, which is a second category matching a second line 522. The electronic device 101 may identify ‘German’, which is a third category matching a third line 523. The electronic device 101 may identify ‘Italian’, which is a fourth category matching a fourth line 524. The electronic device 101 may identify ‘Portuguese’, which is a fifth category matching a fifth line 525. The electronic device 101 may identify ‘English’, which is the first category matching a sixth line 526. The electronic device 101 may identify ‘Korean’, which is a sixth category matching a seventh line 527. The electronic device 101 may generate a table such as Table 1 below showing the number of times the category is identified, based on identifying the category matching the lines 520.

TABLE 1

| category | Number of times identified |
|---|---|
| A first category (English) | twice |
| A second category (Spanish) | once |
| A third category (German) | once |
| A fourth category (Italian) | once |
| A fifth category (Portuguese) | once |
| A sixth category (Korean) | once |

Referring to the Table 1, the electronic device 101 may obtain data identifying ‘English’, which is the first category, twice. The electronic device 101 may obtain data identifying ‘Spanish’, which is the second category, once. The electronic device 101 may obtain data identifying ‘German’, which is the third category, once. The electronic device 101 may obtain data identifying ‘Italian’, which is the fourth category, once. The electronic device 101 may obtain data identifying ‘Portuguese’, which is the fifth category, once. The electronic device 101 may obtain data identifying ‘Korean’, which is the sixth category, once. The electronic device 101 may preset information matching the categories stored in the volatile memory 220 from the non-volatile memory, based on obtaining the data related to the number of times the categories have been identified.

In an example of FIG. 5, the electronic device 101 may identify a category respectively corresponding to the first line 521 to the fourth line 524, in a state 500 in which the first line 521 to the fourth line 524 are identified. The electronic device 101 may store information matching the category from the non-volatile memory to the volatile memory 220, based on identifying the category respectively corresponding to the first line 521 to the fourth line 524. For example, the electronic device 101 may store information corresponding to ‘English’, which is the first category matching a category of characters included in the first line 521, in the first area 531 formed in the volatile memory 220. The electronic device 101 may store information corresponding to ‘Spanish’, which is the second category matching a category of characters included in the second line 522, in a second area 532 formed in the volatile memory 220. The electronic device 101 may store information corresponding to ‘German’, which is the third category matching a category of characters included in the third line 523, in a third area 533 formed in the volatile memory 220. The electronic device 101 may store information corresponding to ‘Italian’, which is the fourth category matching a category of characters included in the fourth line 524, in a fourth area 534 formed in the volatile memory 220. The electronic device 101 may store information corresponding to a category matching each of the first line 521 to the fourth line 524 in areas 531 to 534 formed in the volatile memory 220.

According to an embodiment, the electronic device 101 may identify a category of the fifth line 525 to the seventh line 527, based on characters included in each of the fifth line 525 to the seventh line 527, based on storing the information. The electronic device 101 may identify a category distinguished by language of the characters included in the fifth line 525 to the seventh line 527. The electronic device 101 may identify ‘Portuguese’, which is the fifth category matching a category of characters included in the fifth line 525. The electronic device 101 may store information corresponding to the fifth category from the non-volatile memory to the volatile memory 220, based on identifying ‘Portuguese’, which is the fifth category. The electronic device 101 may store information corresponding to the fifth category in a fifth area 535 formed in the volatile memory 220. The electronic device 101 may identify ‘English’, which is the first category matching a category of characters included in the sixth line 526. The electronic device 101 may identify ‘Korean’, which is the sixth category matching a category of characters included in the seventh line 527. The electronic device 101 may use data included in the Table 1 to store ‘Korean’, which is the sixth category, in the volatile memory 220. For example, the electronic device 101 may identify that ‘English’, which is the first category in the Table 1, has been identified the most times. The electronic device 101 may identify that the number of times that categories different from the first category (e.g., the second category to the fifth category) are identified is relatively smaller than the number of times that the first category is identified. When storing the sixth category, ‘Korean’, in the volatile memory 220, the electronic device 101 may discard one of the second category to the fifth category, which is identified a relatively small number of times. For example, the electronic device 101 may discard the second category, ‘Spanish’, which is identified a relatively small number of times than the first category, in the volatile memory 220. The electronic device 101 may store ‘Korean’, which is the sixth category, in the second area 532 in which the second category was stored, based on discarding the second category from the volatile memory 220. The electronic device 101 may discard information corresponding to the second category matching the second line 522 from the volatile memory 220, in a state 505 in which the first line 521 to the seventh line 527 are identified. The electronic device 101 may store information corresponding to the sixth category matching the seventh line 527, in the second area 532 formed in the volatile memory 220, based on discarding the information corresponding to the second line 522 from the volatile memory 220.

As described above, according to an embodiment, the electronic device 101 may identify a category distinguished by characters included in the lines 520. The electronic device 101 may identify the category matching each of the lines 520. The electronic device 101 may identify the number of times categories are identified. The electronic device 101 may generate a table including data related to the number of times the categories are identified. The electronic device 101 may discard information corresponding to the category stored in the volatile memory 220 based on the data related to the number of times the categories are identified included in the table. The electronic device 101 may adjust a usage of the volatile memory 220 based on the number of times categories are identified. The electronic device 101 may efficiently use the usage of the volatile memory 220, by adjusting the usage of the volatile memory 220, based on the number of times the categories are identified.

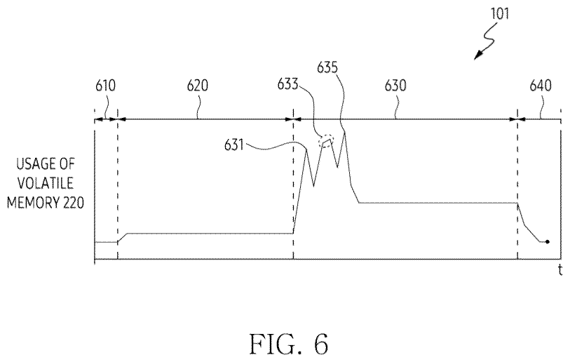

FIG. 6 illustrates an example of a usage of a volatile memory of an electronic device according to an embodiment. An electronic device 101 of FIG. 6 may include the electronic device 101 of FIGS. 1, 2, 3A, 3B, 4A, 4B, and/or 5. Operations of FIG. 6 may be executed by the processor 120 of FIGS. 1, 2, and/or 4B.

Referring to FIG. 6, according to an embodiment, the electronic device 101 may identify a usage of a volatile memory 220. For example, the electronic device 101 may identify lines (e.g., the lines 320 of FIG. 3A, the lines 320 and 340 of FIG. 3B, the lines 420 of FIG. 4A, the lines 420 of FIG. 4B, and/or the lines 520 of FIG. 5). The electronic device 101 may identify a category of the lines based on characters included in the lines, based on identifying the lines. For example, the electronic device 101 may identify the category distinguished by the characters. The electronic device 101 may store information corresponding to the category, from a non-volatile memory to the volatile memory 220, based on identifying the category. The electronic device 101 may identify a usage of the volatile memory 220, based on storing information corresponding to the category in the volatile memory 220.

In an example of FIG. 6, the electronic device 101 may identify a usage of the volatile memory 220 in a first section 610. The first section 610 may indicate an idle state of the electronic device 101. The electronic device 101 may identify a usage of the volatile memory 220 in a second section 620. For example, the second section 620 may be in a state in which an image is displayed in a display (e.g., the display 210 of FIG. 2). For example, the electronic device 101 may be in a state of performing initialization to identify characters included in the image in the second section 620. For example, the electronic device 101 may secure an area of the volatile memory 220 to execute an OCR function in the second section 620. For example, the electronic device 101 may secure an area of the volatile memory 220 to store information from the non-volatile memory to the volatile memory 220.

According to an embodiment, the electronic device 101 may identify a category matching lines based on characters included in the image in a third section 630. The electronic device 101 may identify the category distinguished by the characters included in the lines. The electronic device 101 may identify a category matching each of the lines. The electronic device 101 may identify information corresponding to the category in the non-volatile memory, based on identifying the category matching each of the lines. Based on identifying information corresponding to the category in the non-volatile memory, the electronic device 101 may store it in the volatile memory 220. According to an embodiment, the electronic device 101 may terminate the OCR function executed in a fourth section 640.

In an example of FIG. 6, the electronic device 101 may identify three lines during the third section 630. For example, the electronic device 101 may identify a category of a first line based on characters included in the first line. The electronic device 101 may identify a first category, which is a category distinguished by the characters included in the first line. The electronic device 101 may store first information corresponding to the first category, from the non-volatile memory to the volatile memory 220 based on identifying the first category. When the first information corresponding to the first category is stored, the electronic device 101 may identify a usage of the volatile memory 220. For example, while storing the first information corresponding to the first category, the electronic device 101 may obtain data related to the usage of the volatile memory 220. The electronic device 101 may identify a first time point 631 in the data related to the usage of the volatile memory 220. The first time point 631 may be related to a timing of storing the first information corresponding to the first category, from the non-volatile memory to the volatile memory 220. The electronic device 101 may identify a second line different from the first line. The electronic device 101 may identify a second category corresponding to the second line, based on characters included in the second line. The electronic device 101 may identify the second category distinguished by language of the characters included in the second line. The electronic device 101 may store second information corresponding to the second category, from the non-volatile memory to the volatile memory 220, based on identifying the second category. When storing the second information in the volatile memory 220, the electronic device 101 may identify a second time point 633 related to a timing of storing the second information. According to an embodiment, the electronic device 101 may identify a third line different from the first line and the second line. The electronic device 101 may identify a third category, which is a category corresponding to the third line, based on identifying the third line. The electronic device 101 may identify a category distinguished by language of characters included in the third line. The electronic device 101 may identify the third category, which is the category distinguished by the language of the characters included in the third line. The electronic device 101 may store third information corresponding to the third category, from the non-volatile memory to the volatile memory 220, based on identifying the third category. While storing the third information, the electronic device 101 may identify a usage of the volatile memory 220. The electronic device 101 may identify a third time point 635 related to a timing of storing the third information. When storing the first information to the third information, the electronic device 101 may identify the first time point 631 to the third time point 635 related to an identified peak. The time points 631 to 635 may be identified when information related to a category of characters is stored from the non-volatile memory to the volatile memory 220.

As described above, according to an embodiment, the electronic device 101 may identify a category respectively corresponding to lines. For example, the electronic device 101 may identify categories matching each of the lines based on characters included in the lines. The electronic device 101 may identify the categories matching each of the lines based on language of the characters included in the lines. The electronic device 101 may identify information corresponding to the categories based on identifying the categories matching each of the lines. For example, the electronic device 101 may identify information corresponding to the categories in the non-volatile memory. The electronic device 101 may store the information from the non-volatile memory to the volatile memory 220, based on identifying the information. The electronic device 101 may obtain data related to a timing of storing the information. For example, the electronic device 101 may obtain data related to a usage of the volatile memory 220 related to the timing. The electronic device 101 may identify the timing at which information corresponding to the categories is stored based on the data related to the usage of the volatile memory 220. The electronic device 101 may identify the usage of the volatile memory 220, by identifying the stored timing. The electronic device 101 may provide a user of the electronic device 101 with the usage and/or usable capacity of the volatile memory 220, by identifying the usage of the volatile memory 220.

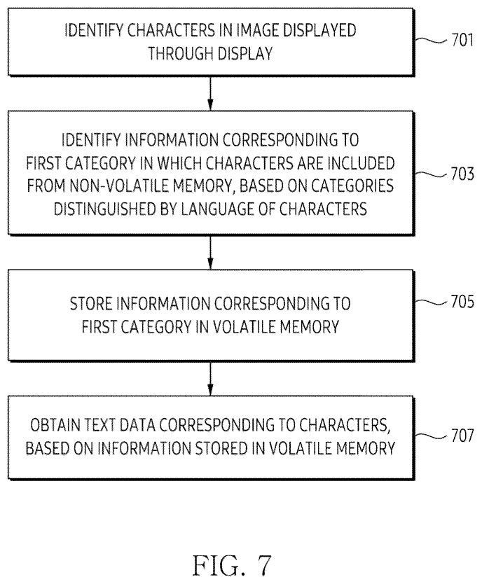

FIG. 7 illustrates an example of a flowchart of an operation of an electronic device according to an embodiment. An electronic device of FIG. 7 may include the electronic device 101 of FIGS. 1, 2, 3A, 3B, 4A, 4B, 5, and/or 6. Operations of FIG. 7 may be executed by the processor 120 of FIGS. 1, 2, and/or 4B.

Referring to FIG. 7, in operation 701, the electronic device according to an embodiment may display an image through a display (e.g., the display module 160 of FIG. 1, and the display 210 of FIGS. 2, 3A, 3B, 4A, 4B, and/or 5). The electronic device may identify characters in the image displayed through the display. For example, the characters may be related to a handwriting character. For example, the handwriting character may include one or more lines drawn on a side by a user to convey a linguistic meaning. However, the disclosure is not limited to the above example embodiment. In an embodiment, the electronic device may identify a category distinguished by language of characters based on identifying the characters.

In operation 703, according to an embodiment, the electronic device may identify, based on identifying the characters in the image displayed through the display, categories distinguished by language of the characters. The electronic device may identify information matching a first category in which characters are included from a non-volatile memory (e.g., the non-volatile memory 134 of FIG. 1 and/or the non-volatile memory 230 of FIG. 2), based on the categories. The electronic device may identify information corresponding to the first category in which the characters are included from the non-volatile memory, based on categories distinguished by language of characters.

In operation 705, according to an embodiment, the electronic device may store information corresponding to the first category in a volatile memory (e.g., the volatile memory 132 of FIG. 1 and/or the volatile memory 220 of FIG. 2). The electronic device may store information in the volatile memory. For example, the electronic device may obtain the information based on characters included in the image. For example, the electronic device may identify a category distinguished by language of the characters based on the characters. For example, the electronic device may identify the first category, which is a category matching the characters. The electronic device may identify information corresponding to the first category. The electronic device may store, based on identifying information corresponding to the first category, the information. For example, the electronic device may store the information corresponding to the first category identified from the non-volatile memory, in the volatile memory. The electronic device may store the information corresponding to the first category stored in the non-volatile memory, in the volatile memory.

In operation 707, according to an embodiment, the electronic device may obtain text data corresponding to characters, based on the information stored in the volatile memory. For example, the electronic device may identify the information corresponding to the first category stored in the volatile memory. The electronic device may obtain text data matching characters based on the information corresponding to the first category. The electronic device may display text related to the characters based on obtaining the text data.

As described above, according to an embodiment, the electronic device may display an image in the display. The electronic device may identify characters in the image. The electronic device may identify the first category in which the characters are included, based on the categories distinguished by language of the characters. The electronic device may identify the information corresponding to the first category stored in the non-volatile memory. The electronic device may store the information corresponding to the first category in the volatile memory. The electronic device may obtain text data corresponding to characters based on the information stored in the volatile memory. The electronic device may efficiently adjust a usage of the volatile memory by storing the information corresponding to the characters in the volatile memory.

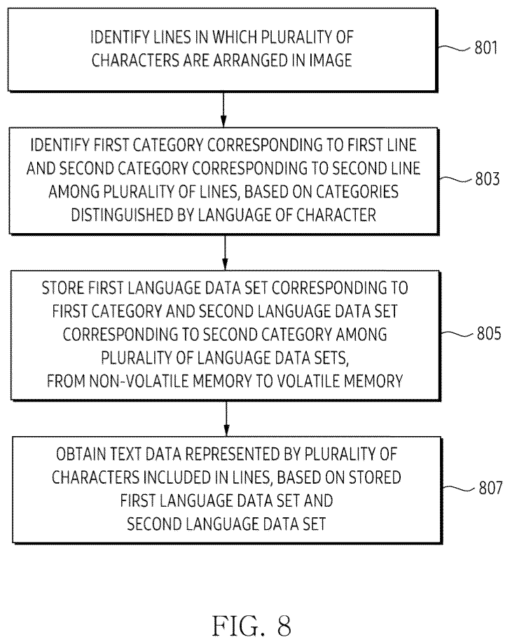

FIG. 8 illustrates an example of a flowchart of an operation of an electronic device according to an embodiment. An electronic device of FIG. 8 may include the electronic device 101 of FIGS. 1, 2, 3A, 3B, 4A, 4B, 5, and/or 6, and/or the electronic device of FIG. 7. Operations of FIG. 8 may be executed by the processor 120 of FIGS. 1, 2, and/or 4B.

Referring to FIG. 8, in operation 801, according to an embodiment, the electronic device may identify lines in which a plurality of characters are arranged in an image. For example, the electronic device may display an image through a display (e.g., the display module 160 of FIG. 1 and/or the display 210 of FIGS. 2, 3A, 3B, 4A, 4B, and/or 5). The electronic device may identify the lines in which the plurality of characters are arranged in the image displayed through the display. For example, the lines may include lines included in a block (e.g., the block 310 of FIG. 3A, the blocks 300 of FIG. 3B, the block 410 of FIG. 4A, the block 410 of FIG. 4B, and/or the block 510 of FIG. 5) identified in the image displayed through the display of the electronic device. For example, one of the lines may include a partial area included in the block (or an area).

In operation 803, according to an embodiment, the electronic device may identify categories distinguished by language of a character. The electronic device may identify a first line among a plurality of lines. The electronic device may identify a first category corresponding to the first line, based on identifying the first line among the plurality of lines. The electronic device may identify a second line among the plurality of lines. The electronic device may identify a second category corresponding to the second line, based on the identification of the second line among the plurality of lines. The electronic device may identify the first category corresponding to the first line among the plurality of lines and the second category corresponding to the second line among the plurality of lines, based on categories distinguished by the language of the character. In the operation 803, when the electronic device identifies categories corresponding to the lines, the number of the lines and/or the number of identifying categories corresponding to the lines are not limited. For example, the electronic device may identify a third line among the plurality of lines. The electronic device may identify a third category corresponding to the third line based on identifying the third line.

In operation 805, according to an embodiment, the electronic device may store a language data set from a non-volatile memory (e.g., the non-volatile memory 230 of FIG. 2) to a volatile memory (e.g., the volatile memory 220 of FIG. 2). The language data set may be referred to as a language DB. The electronic device may identify a first language data set corresponding to the first category among a plurality of language data sets, in the non-volatile memory. The electronic device may store the first language data set, from the non-volatile memory to the volatile memory, based on identifying the first language data set. The electronic device may identify a second language data set corresponding to the second category among the plurality of language data sets, in the non-volatile memory. The electronic device may store the second language data set from the non-volatile memory to the volatile memory, based on identifying the second language data set. The electronic device may store the first language data set corresponding to the first category and the second language data set corresponding to the second category among the plurality of language data sets, from the non-volatile memory to the volatile memory.

In operation 807, according to an embodiment, the electronic device may store the first language data set and the second language data set, from the non-volatile memory to the volatile memory. The electronic device may obtain text data represented by a plurality of characters included in the lines, based on the stored first language data set and the second language data set. The electronic device may display text related to the text data based on obtaining the text data. For example, the electronic device may display the text superimposed in an image. The electronic device may display a visual object including the text, superimposed in the image.

According to an embodiment, the electronic device may identify categories respectively corresponding to the plurality of lines. The electronic device may identify whether the number of the identified categories is greater than a preset number, based on identifying the categories. The electronic device may identify that the number of the identified categories exceeds the preset number. The electronic device may identify frequency of use of the language data set, based on identifying the number of the categories being greater than the preset number. For example, the frequency of use of the language data set may be related to the Table 1 related to the number of identified categories of FIG. 5. The electronic device may discard at least one language data set of the first language data set and the second language data set stored in the volatile memory, based on the frequency of use of the language data set. The electronic device may store a third language data set corresponding to the third category in the volatile memory, based on discarding at least one language data set of the first language data set and the second language data set.

As described above, according to an embodiment, the electronic device may identify lines by which a plurality of characters are arranged. The electronic device may identify categories matching each of the lines. The electronic device may identify a language data set corresponding to the categories in the non-volatile memory, based on identifying the categories matching each of the lines. The electronic device may obtain text data represented by characters included in the lines, based on identifying the language data set. The electronic device may efficiently adjust a usage of the volatile memory, by storing the language data set corresponding to characters arranged in the lines, from the non-volatile memory to the volatile memory.

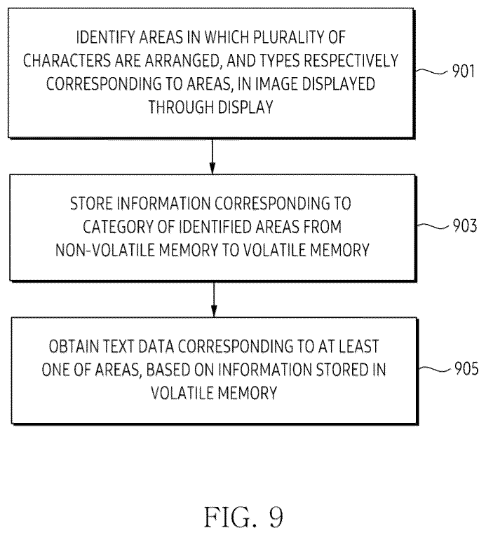

FIG. 9 illustrates an example of a flowchart of an operation of an electronic device according to an embodiment. An electronic device of FIG. 9 may include the electronic device 101 of FIGS. 1, 2, 3A, 3B, 4A, 4B, 5, and/or 6, and the electronic device of FIGS. 7 and/or 8. Operations of FIG. 9 may be executed by the processor 120 of FIGS. 1, 2, and/or 4B.

Referring to FIG. 9, according to an embodiment, the electronic device may display an image through a display (e.g., the display module 160 of FIG. 1, and the display 210 of FIGS. 2, 3A, 3B, 4A, 4B, and/or 5). The electronic device may identify areas (e.g., the blocks 330 of FIG. 3B) in which a plurality of characters are matched, and types respectively corresponding to the areas. For example, a type may be a type of the plurality of characters. For example, the electronic device may identify whether the plurality of characters are printed characters or handwriting characters. The printed characters may be a type of characters represented by the electronic device, or an external electronic device different from the electronic device. The handwriting characters may be a type related to characters drawn by a user. The electronic device may identify printed characters matching a first type. The electronic device may identify handwriting characters matching a second type. The electronic device may identify at least one of the first type or the second type.

In operation 903, according to an embodiment, the electronic device may store information corresponding to a category of the identified areas, from a non-volatile memory (e.g., the non-volatile memory 134 of FIG. 1 and/or the non-volatile memory 230 of FIG. 2) to a volatile memory (e.g., the volatile memory 132 of FIG. 1 and/or the volatile memory 220 of FIG. 2). For example, the electronic device may identify, based on identifying areas in which a plurality of characters are arranged and types respectively corresponding to the areas, categories matching the areas. The electronic device may identify a category of the areas, based on the areas in which the plurality of characters are arranged are identified as the handwriting characters, which is the second type. For example, the electronic device may identify categories of the areas, based on the characters included in the areas. The electronic device may identify the categories matching each of the areas. The electronic device may store information corresponding to a category of the identified areas from the non-volatile memory to the volatile memory.

In operation 905, according to an embodiment, the electronic device may identify the information stored in the volatile memory. The electronic device may obtain text data corresponding to at least one of the areas. The electronic device may obtain text data matching at least one of the identified areas, based on the information stored in the volatile memory. For example, the electronic device may obtain text data matching the characters included in the areas. For example, the electronic device may obtain text data for converting the characters into text. The electronic device may obtain text data for displaying the characters as text.

As described above, according to an embodiment, the electronic device may identify types of areas. For example, the electronic device may identify categories matching the areas identified as the second type, based on identifying the handwriting characters, which is the second type among the types of the areas. The electronic device may identify information respectively corresponding to the categories, based on identifying categories matching the areas identified as the second type. The electronic device may identify the information respectively corresponding to the categories, stored in the non-volatile memory. The electronic device may store the information from the non-volatile memory to the volatile memory, based on identifying the information respectively corresponding to the categories stored in the non-volatile memory. The electronic device may efficiently use a usage of the volatile memory by storing the information related to the categories of the plurality of areas from the non-volatile memory to the volatile memory based on the type of the plurality of areas.

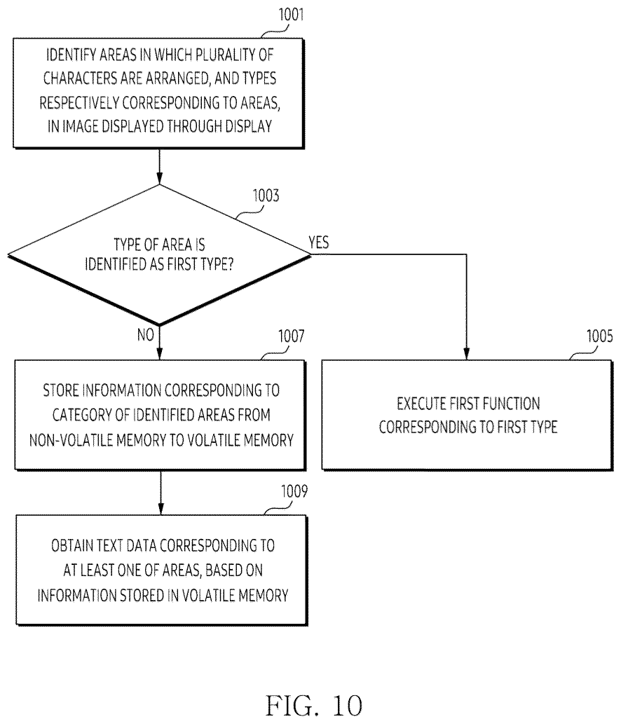

FIG. 10 illustrates an example of a flowchart of an operation of an electronic device according to an embodiment. An electronic device of FIG. 10 may include the electronic device 101 of FIGS. 1, 2, 3A, 3B, 4A, 4B, 5, and/or 6, and the electronic device of FIGS. 7, 8, and/or 9. Operations of FIG. 10 may be executed by the processor 120 of FIGS. 1, 2, and/or 4B.

Referring to FIG. 10, in operation 1001, according to an embodiment, the electronic device may identify areas in which a plurality of characters are arranged, and types respectively corresponding to the areas, in an image displayed through a display (e.g., the display module 160 of FIG. 1 and the display 210 of FIGS. 2, 3A, 3B, 4A, 4B, and/or 5). For example, the types may include a first type and a second type. For example, the first type may be a case in which characters included in the image displayed through the display of the electronic device are printed characters. For example, the second type may be a case in which the characters included in the image displayed through the display of the electronic device are handwriting characters. The operation 1001 of FIG. 10 may be executed similarly to the operation 901 of FIG. 9. The operation 1001 of FIG. 10 may be substantially the same as the operation 901 of FIG. 9.

In operation 1003, according to an embodiment, the electronic device may identify a type of a plurality of areas. For example, the electronic device may identify at least one type of the plurality of areas. The electronic device may identify whether at least one type of the plurality of areas is identified as the first type. According to an embodiment, the electronic device 101 may identify that the at least one type of the plurality of areas is the first type.

In a case that the type of the area is identified as the first type (the operation 1003—YES), in an operation 1005, according to an embodiment, the electronic device may execute a first function corresponding to the first type. The electronic device may execute the first function matching the first type. The first function may include a function that is executed based on the characters included in the image being printed characters. The electronic device may obtain text data of characters included in the area identified as the first type, based on executing the first function. The electronic device may execute the first function, based on an operation different from that of obtaining text data of characters included in the area identified as the second type.

In a case that the type of the area is not identified as the first type (the operation 1003—NO), in operation 1007, according to an embodiment, the electronic device may store information corresponding to a category of the identified areas from a non-volatile memory (e.g., the non-volatile memory 134 of FIG. 1 and/or the non-volatile memory 230 of FIG. 2) to a volatile memory (e.g., the volatile memory 132 of FIG. 1 and/or the volatile memory 220 of FIG. 2). The operation 1007 may be executed similarly to the operation 903. The operation 1007 may be executed substantially identically to the operation 903.

In operation 1009, according to an embodiment, the electronic device may identify information stored in the volatile memory. For example, the electronic device may identify information related to a category matching an area included in an image. The electronic device may obtain text data corresponding to at least one of the areas, based on the information stored in the volatile memory. The electronic device may display text for expressing characters included in the area based on the obtained text data.

As described above, according to an embodiment, the electronic device may identify types of areas. For example, the electronic device may execute functions corresponding to the types of the areas. For example, the electronic device may execute the first function to obtain text data related to characters included in an area identified as the first type. For example, the electronic device may execute a second function to obtain text data related to characters included in an area identified as the second type. The electronic device may execute a different function according to the type of the area. The electronic device may efficiently adjust a usage of the volatile memory by executing the different function based on the type of the area.

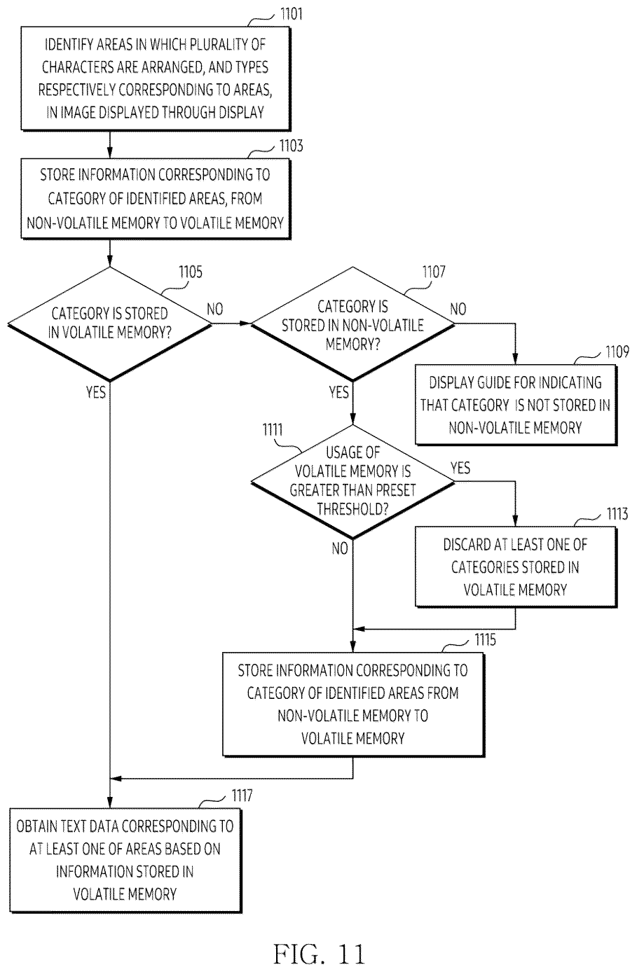

FIG. 11 illustrates an example of a flowchart of an operation of an electronic device according to an embodiment. An electronic device of FIG. 11 may include the electronic device 101 of FIGS. 1, 2, 3A, 3B, 4A, 4B, and/or 5, and the electronic device of FIGS. 6, 7, 8, 9, and/or 10. Operations of FIG. 11 may be executed by the processor 120 of FIGS. 1, 2, and/or 4B.

Referring to FIG. 11, in operation 1101, according to an embodiment, the electronic device may display an image through a display (e.g., the display module 160 of FIG. 1 and/or the display 210 of FIG. 2). The electronic device may identify a plurality of characters in the image displayed through the display. The electronic device may identify areas including the plurality of characters in the image displayed through the display. The electronic device may identify areas in which the plurality of characters are arranged, and types respectively corresponding to the areas, in the image displayed through the display. The operation 1101 of FIG. 11 may be executed similarly to the operation 903 of FIG. 9 and/or the operation 1001 of FIG. 10.

In operation 1103, according to an embodiment, the electronic device may store information corresponding to a category of identified areas, from a non-volatile memory (e.g., the non-volatile memory 136 of FIG. 1 and/or the non-volatile memory 230 of FIG. 2) to a volatile memory (e.g., the volatile memory 220 of FIG. 1 and/or the volatile memory 220 of FIG. 2). The operation 1103 of FIG. 11 may be executed similarly to the operation 1007 of FIG. 10 and/or the operation 903 of FIG. 9.

In operation 1105, according to an embodiment, the electronic device may identify whether information corresponds to a category stored in the volatile memory, based on storing information corresponding to the category of identified areas in the volatile memory. In case of identifying a category matching the information stored in the volatile memory, the electronic device may execute operation 1117.

In a case that it is not a category stored in the volatile memory (the operation 1105—NO), in operation 1107, according to an embodiment, the electronic device may identify whether the category is stored in the non-volatile memory. For example, the electronic device may identify a category distinguished by characters included in the area. The electronic device may identify whether the category is stored in the non-volatile memory. The electronic device may identify whether information corresponding to the category is stored in the non-volatile memory. The electronic device may identify whether the category is stored in the non-volatile memory, based on identifying a category that is not stored in the volatile memory.

In a case that it is not a category stored in the non-volatile memory (the operation 1107—NO), in operation 1109, according to an embodiment, the electronic device may display a guide for indicating that the category is not stored in the non-volatile memory. For example, the electronic device may identify that characters included in the area do not match the category stored in the non-volatile memory. The electronic device may display a guide for indicating that the category is not stored in the non-volatile memory, based on identifying that the characters do not match the category stored in the non-volatile memory. The electronic device may display a visual object related to the guide through the display. For example, the visual object related to the guide may be displayed through the display, such as ‘There is no recognition result.’.

In a case that the category is stored in the non-volatile memory (the operation 1107—YES), in operation 1111, according to an embodiment, the electronic device may identify a usage of the volatile memory. The electronic device may identify whether the usage of the volatile memory is greater than a preset threshold. The electronic device may identify a usable capacity of an area for executing a function allocated to the volatile memory. The electronic device may identify whether the usable capacity is less than or equal to the preset threshold.

In a case that the usage of the volatile memory exceeds (the operation 1111—YES), in operation 1113, according to an embodiment, the electronic device may discard at least one of categories stored in the volatile memory. The electronic device may discard at least one of information of the categories stored in the volatile memory. The electronic device may discard at least one of information of categories occupying an area formed in the volatile memory.

In operation 1115, according to an embodiment, the electronic device may store information corresponding to the category of the identified areas from the non-volatile memory to the volatile memory. The operation 1115 of FIG. 11 may be executed similarly to the operation 1007 of FIG. 10 and/or the operation 903.

In a case that the category is stored in the volatile memory (the operation 1105—YES), in the operation 1117, according to an embodiment, the electronic device may obtain text data corresponding to at least one of the areas based on information stored in the volatile memory. The electronic device may obtain text data matching characters included in the areas. The electronic device may obtain text data for expressing the characters. The electronic device may superimpose and display text related to the text data on at least a portion of the image displayed through the display, based on obtaining the text data.

As described above, according to an embodiment, the electronic device may identify areas in which a plurality of characters are arranged, in an image displayed through the display. The electronic device may identify types respectively corresponding to the areas. The electronic device may store information corresponding to a category of the identified areas from the non-volatile memory to the volatile memory, based on a type of the areas being identified as a second type among a first type and the second type. The electronic device may obtain text data corresponding to at least one of the areas, based on the information stored in the volatile memory, based on identifying the category stored in the volatile memory. The electronic device may identify whether a category of an area is a category stored in the non-volatile memory based on identifying that the category of the area is not a category stored in the volatile memory. The electronic device may display a guide for indicating that the category is not stored in the non-volatile memory, based on identifying that the category of the area is not stored in the non-volatile memory. The electronic device may identify a usage of the volatile memory, based on the category of the area being the category stored in the non-volatile memory. The electronic device may identify that the usage of the volatile memory exceeds the preset threshold. The electronic device may discard at least one of the categories stored in the volatile memory, based on the usage of the volatile memory exceeding the preset threshold. The electronic device may store information corresponding to a category of the identified areas from the non-volatile memory to the volatile memory, based on the usage of the volatile memory being not greater than the preset threshold. The electronic device may store the information corresponding to the category of the identified areas from the non-volatile memory to the volatile memory, based on discarding at least one of the categories stored in the volatile memory. The electronic device may obtain text data corresponding to at least one of the areas based on storing the information. The electronic device may obtain text data matching characters included in the areas. The electronic device may display text matching the text data through the display, based on obtaining the text data. When storing the information related to the category in the volatile memory, the electronic device may efficiently adjust the usage of the volatile memory, by storing only the category corresponding to the areas.

The electronic device may execute an OCR function for obtaining text matching handwriting characters. While executing the OCR function, a method of efficiently using the usage of the volatile memory may be required.

As described above, according to an embodiment, an electronic device 101 may comprise a non-volatile memory 134 or 230, a volatile memory 132 or 220, a display 210, and a processor 120. The processor 120 may identify characters in an image displayed through the display 210. The processor 120 may identify, based on categories distinguished by language of the characters, information, from the non-volatile memory 134 or 230, corresponding to a first category in which the characters are included. The processor 120 may store, in the volatile memory 132 or 220, the information corresponding to the first category. The processor 120 may obtain text data corresponding to the characters based on the information stored in the volatile memory 132 or 220. The electronic device 101 may efficiently use a usage of the volatile memory 132 or 220, by storing information related to a category corresponding to the characters, from the non-volatile memory 134 or 230 to the volatile memory 132 or 220 based on the characters.

According to an embodiment, the processor 120 may, based on identifying a plurality of lines 320, 340, 420, or 520 by which the characters are arranged in the image, store, in the volatile memory 132 or 220, information stored in the non-volatile memory 134 or 230 based on categories of each of the lines 320, 340, 420, or 520.

According to an embodiment, the processor 120 may obtain, by executing threads 441 or 442 respectively corresponding to the plurality of lines 320, 340, 420, or 520, text data respectively corresponding to the plurality of lines 320, 340, 420, or 520.

According to an embodiment, the processor 120 may identify, based on identifying a block including the plurality of lines 320, 340, 420, or 520 by which the characters are arranged, the plurality of lines 320, 340, 420, or 520 included in the block.

According to an embodiment, the processor 120 may bypass, in response to identifying information corresponding to the first category in the volatile memory 132 or 220, storing the information corresponding to the first category in the volatile memory 132 or 220.

According to an embodiment, the processor 120 may discard, based on identifying other information corresponding to a category different from the first category from the volatile memory 132 or 220, the other information from the volatile memory 132 or 220 based on a usage of the volatile memory 132 or 220.

According to an embodiment, the processor 120 may identify the usage with respect to a portion in the volatile memory 132 or 220 that is set to store information used to obtain text from characters included in the image.

According to an embodiment, the processor 120 may identify, based on a number of information corresponding to categories stored in the volatile memory 132 or 220, the usage of the volatile memory 132 or 220.

As described above, according to an embodiment, a method of an electronic device 101 may comprise identifying characters in an image displayed through a display 210. The method of the electronic device 101 may comprise identifying, based on categories distinguished by language of the characters, information, from the non-volatile memory 134 or 230, corresponding to a first category in which the characters are included. The method of the electronic device 101 may comprise storing, in the volatile memory 132 or 220, the information corresponding to the first category. The method of the electronic device 101 may comprise obtaining text data corresponding to the characters based on the information stored in the volatile memory 132 or 220.

According to an embodiment, the method of the electronic device 101 may comprise, based on identifying a plurality of lines 320, 340, 420, or 520 by which the characters are arranged in the image, storing, in the volatile memory 132 or 220, information stored in the non-volatile memory 134 or 230 based on categories of each of the lines 320, 340, 420, or 520.

According to an embodiment, the method of the electronic device 101 may comprise obtaining, by executing threads 441 or 442 respectively corresponding to the plurality of lines 320, 340, 420, or 520, text data respectively corresponding to the plurality of lines 320, 340, 420, or 520.

According to an embodiment, the method of the electronic device 101 may comprise identifying, based on identifying a block including the plurality of lines 320, 340, 420, or 520 by which the characters are arranged, the plurality of lines 320, 340, 420, or 520 included in the block.

According to an embodiment, the method of the electronic device 101 may comprise bypassing, in response to identifying information corresponding to the first category in the volatile memory 132 or 220, storing the information corresponding to the first category in the volatile memory 132 or 220.

According to an embodiment, the method of the electronic device 101 may comprise discarding, based on identifying other information corresponding to a category different from the first category from the volatile memory 132 or 220, the information from the volatile memory 132 or 220 based on a usage of the volatile memory 132 or 220.

According to an embodiment, the method of the electronic device 101 may comprise identifying the usage with respect to a portion in the volatile memory 132 or 220 that is set to store information used to obtain text from characters included in the image.

According to an embodiment, the method of the electronic device 101 may comprise identifying, based on a number of information corresponding to categories stored in the volatile memory 132 or 220, the usage of the volatile memory 132 or 220.

As described above, according to an embodiment, a method of an electronic device 101 may comprise identifying, in an image displayed through a display 210 in the electronic device 101, lines 320, 340, 420, or 520 by which a plurality of characters are arranged. The method of the electronic device 101 may comprise identifying, based on categories distinguished by language of a character, categories respectively corresponding to the plurality of lines 320, 340, 420, or 520. The method of the electronic device 101 may comprise storing information respectively corresponding to the identified categories from a non-volatile memory 134 or 230 to a volatile memory 132 or 220, in the electronic device 101. The method of the electronic device 101 may comprise obtaining, based on the stored information, text data represented by the plurality of characters included in the lines 320, 340, 420, or 520.

According to an embodiment, the method of the electronic device 101 may comprise identifying, based on a block included in the image, the plurality of lines 320, 340, 420, or 520. The method of the electronic device 101 may comprise identifying, based on identifying the plurality of lines 320, 340, 420, or 520, categories respectively corresponding to the plurality of lines 320, 340, 420, or 520.

According to an embodiment, the method of the electronic device 101 may comprise identifying a first category among the categories from the volatile memory 132 or 220. The method of the electronic device 101 may comprise discarding, based on identifying a category different from the first category, the information from the volatile memory 132 or 220 based on a usage of the volatile memory 132 or 220.

According to an embodiment, the method of the electronic device 101 may comprise identifying, based on a number of the information corresponding to the categories, the usage of the volatile memory 132 or 220.

As described above, according to an embodiment, an electronic device 101 may comprise a display 210, a non-volatile memory 134 or 230, a volatile memory 132 or 220, and a processor 120. The processor 120 may identify, in an image displayed through the display 210, lines 320, 340, 420, or 520 by which a plurality of characters are arranged. The processor 120 may identify, based on categories distinguished by language of a character, categories respectively corresponding to the plurality of lines 320, 340, 420, or 520. The processor 120 may store information respectively corresponding to the identified categories from the non-volatile memory 134 or 230 to the volatile memory 132 or 220. The processor 120 may obtain, based on the stored information, text data represented by the plurality of characters included in the lines 320, 340, 420, or 520.

According to an embodiment, an electronic device 101 may comprise a display, a non-volatile memory 134 or 230, a volatile memory 132 or 220, and a processor 120. The non-volatile memory 134 or 230 may store a plurality of language data sets including a first language data set, a second language data set, and a third language data set. The processor 120 may identify, in an image, lines 320, 340, 420, or 520 by which a plurality of characters are arranged. The processor 120 may store, based on categories distinguished by language of a character, the first language data set corresponding to a first category, and the second language data set corresponding to the second category among the plurality of lines. The processor 120 may obtain, based on the stored first language data set and the second language data set, text data represented by the plurality of characters included in the lines 320, 340, 420, or 520.

According to an embodiment, the processor 120 may identify, based on a block included in the image, the plurality of lines 320, 340, 420, or 520. The processor 120 may identify, based on identifying the plurality of lines 320, 340, 420, or 520, categories respectively corresponding to the plurality of lines 320, 340, 420, or 520.

According to an embodiment, the processor 120 may identify a third category corresponding to a third line among the plurality of lines. The processor 120 may identify that a number of the identified categories is greater than a preset number. The processor 120 may discard, based on that the number of the identified categories is greater than the preset number, at least one language data set among the first language data set and the second language data set from the volatile memory 132 or 220. The processor 120 may store, in the volatile memory 132 or 220, the third language data set corresponding to the third category.

According to an embodiment, the processor 120 may identify a first category among the categories, from the volatile memory 132 or 220. The processor 120 may discard, based on identifying a category different from the first category, the information from the volatile memory 132 or 220 based on a usage of the volatile memory 132 or 220.

According to an embodiment, the processor 120 may identify, based on a number of the language data set corresponding to the categories, a usage of the volatile memory 132 or 220.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through a wire), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a first memory comprising one or more storage media storing instructions;
a second memory;
a display; and
at least one processor comprising processing circuitry, wherein the instructions, when executed by the at least one processor individually or collectively, cause the electronic device to:
identify characters in an image displayed through the display;
identify, based on categories distinguished by language of the characters, information, from the first memory, corresponding to a first category in which the characters are included;
store, in the second memory, the information corresponding to the first category; and
obtain text data corresponding to the characters, based on the information stored in the second memory.

2. The electronic device of claim 1, wherein the first memory is a non-volatile memory and the second memory is a volatile memory, and
wherein the instructions, when executed by the at least one processor individually or collectively, cause the electronic device to, based on identifying a plurality of lines by which the characters are arranged in the image, store, in the second memory, the information stored in the first memory based on the categories of each of the plurality of lines.

3. The electronic device of claim 2, wherein the instructions, when executed by the at least one processor individually or collectively, cause the electronic device to obtain, by executing threads respectively corresponding to the plurality of lines, text data respectively corresponding to the plurality of lines.

4. The electronic device of claim 2, wherein the instructions, when executed by the at least one processor individually or collectively, cause the electronic device to identify, based on identifying a block including the plurality of lines by which the characters are arranged, the plurality of lines included in the block.

5. The electronic device of claim 1, wherein the first memory is a non-volatile memory and the second memory is a volatile memory, and
wherein the instructions, when executed by the at least one processor individually or collectively, cause the electronic device to, based on identifying information corresponding to the first category in the second memory, bypass storing the information corresponding to the first category in the second memory.

6. The electronic device of claim 1, wherein the first memory is a non-volatile memory and the second memory is a volatile memory, and
wherein the instructions, when executed by the at least one processor individually or collectively, cause the electronic device to based on identifying other information corresponding to a category that is different from the first category from the second memory, discard the other information from the second memory based on a usage of the second memory.

7. The electronic device of claim 6, wherein the instructions, when executed by the at least one processor individually or collectively, cause the electronic device to identify the usage with respect to a portion in the second memory that is set to store information used to obtain text from the characters included in the image.

8. The electronic device of claim 6, wherein the instructions, when executed by the at least one processor individually or collectively, cause the electronic device to identify, based on a number of information corresponding to the categories stored in the second memory, the usage of the second memory.

9. A method of an electronic device, the method comprising:
identifying characters in an image displayed through a display;
identifying, based on categories distinguished by language of the characters, information, from the first memory, corresponding to a first category in which the characters are included;
storing, in a second memory, the information corresponding to the first category; and
obtaining text data corresponding to the characters based on the information stored in the second memory.

10. The method of claim 9, wherein the first memory is a non-volatile memory and the second memory is a volatile memory, and
wherein the method further comprises, based on identifying a plurality of lines by which the characters are arranged in the image, storing, in the second memory, information stored in the first memory based on the categories of each of the plurality of lines.

11. The method of claim 10, further comprising obtaining, by executing threads respectively corresponding to the plurality of lines, text data respectively corresponding to the plurality of lines.

12. The method of claim 10, further comprising based on identifying a block including the plurality of lines by which the characters are arranged, identifying the plurality of lines included in the block.

13. The method of claim 9, wherein the first memory is a non-volatile memory and the second memory is a volatile memory, and
wherein the method further comprises based on identifying information corresponding to the first category in the second memory, bypassing storing the information corresponding to the first category in the second memory.

14. The method of claim 9, wherein the first memory is a non-volatile memory and the second memory is a volatile memory, and
wherein the method further comprises based on identifying other information corresponding to a category that is different from the first category from the second memory, discarding the information from the second memory based on a usage of the second memory.

15. The method of claim 14, further comprising identifying the usage with respect to a portion in the second memory that is set to store information used to obtain text from characters included in the image.

16. The method of claim 14, further comprising identifying, based on a number of information corresponding to the categories stored in the second memory, the usage of the second memory.

17. An electronic device comprising,
a display;
a first memory storing a plurality of language data sets including a first language data set, a second language data set, and a third language data set;
a second memory; and
a processor operatively connected to the display, the first memory and the second memory, wherein the processor is configured to:
identify, in an image, lines by which a plurality of characters are arranged;
identify, based on categories distinguished by language of a character, a first category corresponding to a first line, and a second category corresponding to a second line among a plurality of lines;
store, from the first memory to the second memory, the first language data set corresponding to the first category, and the second language data set corresponding to the second category among the plurality of language data sets; and
obtain, based on the stored first language data set and the second language data set, text data represented by the plurality of characters included in the lines.

18. The electronic device of claim 17, wherein the first memory is a non-volatile memory and the second memory is a volatile memory, and
wherein the processor is further configured to:
identify, based on a block included in the image, the plurality of lines; and
based on identifying the plurality of lines, identify the categories respectively corresponding to the plurality of lines.

19. The electronic device of claim 17, wherein the first memory is a non-volatile memory and the second memory is a volatile memory, and
wherein the processor is further configured to:
identify a third category corresponding to a third line among the plurality of lines;
identify that a number of the identified categories is greater than a preset number;
based on the number of the identified categories being greater than the preset number and based on a frequency of use of the plurality of language data sets, discard at least one language data set among the first language data set and the second language data set from the second memory; and
store, in the second memory, the third language data set corresponding to the third category.

20. The electronic device of claim 19, wherein the processor is further configured to identify, based on a number of the plurality of language data sets corresponding to the categories, a usage of the second memory.
